(19) United States
(12) Patent Application Publication
(10) Pub. No.: US 2024/0414507 A1
(43) Pub. Date: Dec. 12, 2024

(54) DATA COLLECTION SYSTEM, MOBILE BASE STATION EQUIPMENT AND DATA COLLECTION METHOD

(71) Applicant: NIPPON TELEGRAPH AND TELEPHONE CORPORATION, Tokyo (JP)

(72) Inventors: Ryota SHIINA, Musashino-shi, Tokyo (JP); Shinya TAMAKI, Musashino-shi, Tokyo (JP); Tomohiro TANIGUCHI, Musashino-shi, Tokyo (JP); Yasutaka KIMURA, Musashino-shi, Tokyo (JP)

(73) Assignee: NIPPON TELEGRAPH AND TELEPHONE CORPORATION, Tokyo (JP)

(21) Appl. No.: 18/699,865

(22) PCT Filed: Oct. 13, 2021
(86) PCT No.: PCT/JP2021/037834

§ 371 Date: Apr. 9, 2024

(51) Int. Cl. H04W 4/38; H04L 43/12

(52) U.S. Cl. CPC H04W 4/38; H04L 43/12

(57) ABSTRACT

An object of this disclosure is to reduce a total time required for data collection and improve data collection efficiency.

According to this disclosure, there is provided a data collecting system in which a mobile base station apparatus collects data from a plurality of terminal devices arranged in a distributed manner. The mobile base station apparatus collects flag information from each terminal device of the plurality of terminal devices, the flag information indicating that the corresponding terminal device has data to be collected, by using a control signal before establishing communication with the terminal device, calculates a data collection route for collecting data from the terminal device by using the flag information; and collects data from the terminal device by moving along the calculated data collection route.

### TECHNICAL FIELD

This disclosure relates to a data collecting technology.

### BACKGROUND ART

As a system for collecting sensing data in the Internet of things (IoT), a system has been proposed in which a mobile node moves in a sensing area and directly collects data from each sensor terminal (see, for example, Non Patent Literature 1). In Non Patent Literature 1, in order to maximize an amount of data collection, information is collected from one sensor terminal, and data of sensor terminals around the one sensor terminal is predicted based on the collected data.

In the system of Non Patent Literature 1, it is necessary to install a base station for sensing, and it is difficult to deploy sensor terminals in a wide area and in a distributed manner from a viewpoint of costs. In addition, in a wide-area communication system, since a data rate is relatively small in terms of frequency, it is not suitable to collect a large amount of data or to collect data collectively.

On the other hand, as described in Non Patent Literature 1, in a case where a mobile base station is used, the mobile base station moves at a certain moving speed, and omission of data collection is likely to occur. In a case where data of all sensor terminals is to be collected in a short time, the number of sensor terminals that can actually collect data is limited, and this may result in a case where data cannot be collected from sensor terminals from which data should originally be collected.

In order to avoid omitting data collection and secure a sufficient data collection time, it is necessary to reduce a speed of the mobile base station and increase the time allocated per sensor terminal. However, in a case where the data collection is performed on all sensor terminals, the time for data collection increases dramatically, and there is a concern about an influence on a battery or the like when a mobile base station such as a flight vehicle is assumed.

### CITATION LIST

### Non Patent Literature

Non Patent Literature 1: Wataru Seino, Tomoki Yoshihisa, Takahiro Hara, and Shojiro Nishio, “A Communication Traffic Reduction Method by Delivering Predicted Values on Sensor Data Collection with a Mobile Sink”, in Collection of Papers, from Multimedia, Distributed, Cooperative, and Mobile Symposium 2011, pp. 1175-1182, 2011.
Non Patent Literature 2: IEEE Standards Association. “IEEE Std 802.11-2016, IEEE Standard for Local and Metropolitan Area Networks-Part 11: Wireless LAN Medium Access Control (MAC) and Physical Layer (PHY) Specifications, 2016.”

### SUMMARY OF INVENTION

### Technical Problem

An object of this disclosure is to reduce a total time required for data collection and improve data collection efficiency.

### Solution to Problem

A data collecting system of this disclosure includes: a mobile base station apparatus of this disclosure; and a plurality of terminal devices.

The mobile base station apparatus of this disclosure executes a method for collecting data in which the mobile base station apparatus collects data from the plurality of terminal devices arranged in a distributed manner.

According to this disclosure, there is provided a method for collecting data in which a mobile base station apparatus collects data from a plurality of terminal devices arranged in a distributed manner, the method including: by the mobile base station apparatus, collecting flag information from each terminal device of the plurality of terminal devices, the flag information indicating that the corresponding terminal device has data to be collected, by using a control signal before establishing communication with the terminal device, calculating a data collection route for collecting data from the terminal device by using the flag information; and collecting data from the terminal device by moving through the calculated data collection route.

### Advantageous Effects of Invention

According to this disclosure, a total time required for data collection can be reduced, and data collection efficiency can be improved.

### BRIEF DESCRIPTION OF DRAWINGS

FIG. 1 illustrates a configuration example of a system of this disclosure.

FIG. 2 illustrates an example of a frame structure of a control signal.

FIG. 3 illustrates an example of a circuit route for collecting flag information.

FIG. 4 illustrates an example of a data collection route for collecting sensing data.

FIG. 5 illustrates a configuration example of a sensor terminal 10.

FIG. 6 illustrates a configuration example of a mobile base station 20.

FIG. 7 illustrates an example of a flowchart for collecting flag information.

FIG. 8 illustrates an example of a flowchart for collecting sensing data.

FIG. 9 illustrates another configuration example of a sensor terminal 10.

FIG. 10 illustrates another configuration example of a mobile base station 20.

FIG. 11 illustrates an example of a flowchart for collecting metadata.

### DESCRIPTION OF EMBODIMENTS

Hereinafter, embodiments of this disclosure will be described in detail with reference to the drawings. Further, this disclosure is not limited to the embodiments to be described below. These embodiments are merely exemplary, and this disclosure can be carried out in forms of various modifications and improvements based on the knowledge of those skilled in the art. Further, configurational components having the same reference numerals in this specification and the drawings denote the same configurational components.

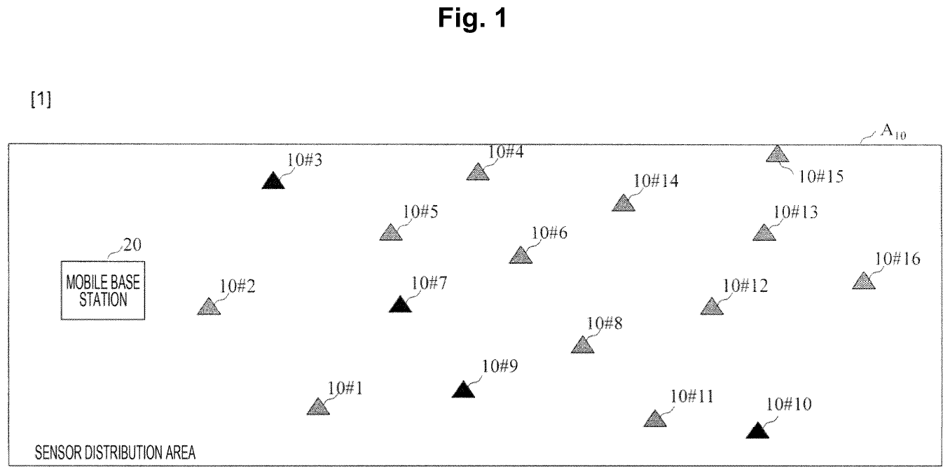

FIG. 1 illustrates a configuration example of a system of this disclosure. A data collecting system of this disclosure includes a plurality of sensor terminals 10 and a mobile base station 20 that collects sensing data from the sensor terminals 10. The sensor terminal 10 functions as a terminal device according to this disclosure, and the mobile base station 20 functions as a mobile base station apparatus according to this disclosure. The mobile base station 20 is any device that can move on land or in the air, and for example, can be exemplified by a manned or unmanned aircraft.

In the embodiment, a model is assumed in which there is no facility such as a base station around the sensor terminals 10, and the sensor terminals 10 are distributed in a predetermined sensor distribution area A₁₀. The sensor distribution area A₁₀ includes a wide area such as several kilometers to several tens of kilometers. In addition, in the embodiment, each sensor terminal 10 is set to transmit sensing data to an upper rank only in a case where an event has occurred for a large amount of sensing data gathered for several days, several hours, or the like before and after the occurrence of the event. In the embodiment, in order to collect gathered sensing data, when the mobile base station 20 collects sensing data, data communication by transmission control protocol/Internet protocol (TCP/IP) is established with the sensor terminals 10, and then sensing data is downloaded.

### (1) First Feature of this Disclosure

In the data collecting system of this disclosure, flag determination for collecting sensing data is performed for each sensor terminal 10. For example, in a case where sensing data to be transmitted to a higher rank is present in a group of sensor terminals 10, the mobile base station 20 determines that the sensor terminal 10 is a “flagged sensor”. On the other hand, in a case where there is no sensing data to be transmitted to the upper rank, it is determined that the sensor is the “no-flag sensor”.

In FIG. 1, when the sensor terminals 10 that collect sensing data are sensor terminals 10 #3, 10 #7, 10 #9, and 10 #10, the mobile base station 20 determines that the sensor terminals 10 #3, 10 #7, 10 #9, and 10 #10 are flagged sensors. When there is no sensing data to be collected in the sensor terminals 10 #1, 10 #2, 10 #4 to 10 #6, 10 #8, and 10 #11 to 10 #16, the mobile base station 20 determines that the sensor terminals 10 #1, 10 #2, 10 #4 to 10 #6, 10 #8, and 10 #11 to 10 #16 are no-flag sensors.

### (2) Second Feature of this Disclosure

The sensor terminal 10 transmits the fact that the sensor terminal is a flagged sensor to the mobile base station 20 by using a control signal of a wireless communication protocol which is transmitted and received before establishing data communication with the mobile base station 20.

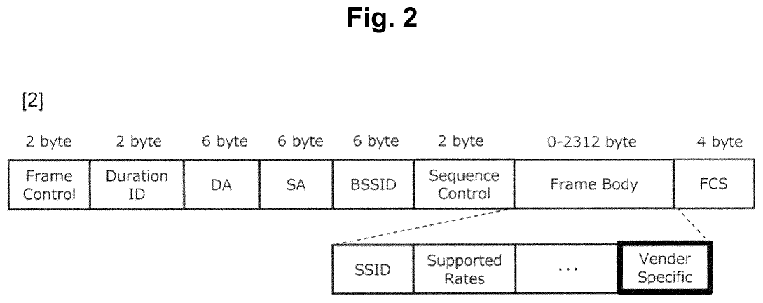

FIG. 2 illustrates an example of a frame structure of a control signal. In this disclosure, the sensor terminal 10 and the mobile base station 20 perform data communication using wireless communication. In this case, a probe request frame defined by IEEE 802.11 (see Non Patent Literature 2) can be used as the control signal. A storage location of the flag information indicating that the sensor is a flagged sensor is any location, but for example, the flag information can be inserted into a unique extension region such as a vender specific region of a probe request.

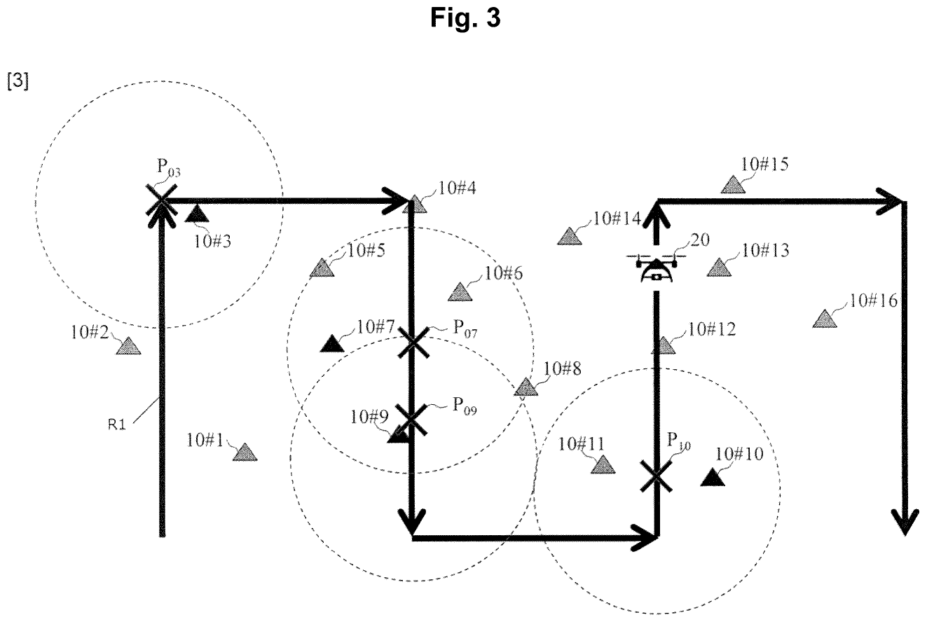

FIG. 3 illustrates an example of a circuit route for collecting flag information. The mobile base station 20 moves along a circuit route R1 along which flag information can be collected from all the sensor terminals 10 in the sensor distribution area A₁₀. Consequently, the mobile base station 20 can receive the flag information transmitted from the sensor terminals 10 #3, 10 #7, 10 #9, and 10 #10, which are flagged sensors, by using the control signal.

Here, the collection of the flag information may be performed only by transmission and reception of a control signal of a wireless communication protocol. Therefore, the mobile base station 20 can move along the predetermined circuit route R1 as fast as possible. The mobile base station 20 can receive only the flag information even in a situation where the TCP/IP communication is not established by receiving the flag information via the control signal transmitted from the flagged sensor.

The mobile base station 20 stores any information with which a position where the flag information is received can be identified. For example, the mobile base station 20 may capture a time when the flag information is received and position information on the circuit route R1 at the time when the flag information is received. By acquiring the reception time, it is possible to improve the identification accuracy of the sensor terminal 10 that has transmitted the flag information. In that case, the transmission time of the flag information from the sensor terminal 10 and the reception time of the flag information of the mobile base station 20 may be matched to identify the sensor terminal 10 of the flagged sensor.

### (3) Third Feature of this Disclosure

The mobile base station 20 aggregates the flag information from each sensor terminal 10 and calculates the shortest route passing through positions where the flag information is received as a circuit data collection route R2. Consequently, the mobile base station 20 collectively collects data to be collected after establishing data communication using the data collection route R2 on which the mobile base station 20 approaches only the necessary sensor terminal 10 by the shortest route.

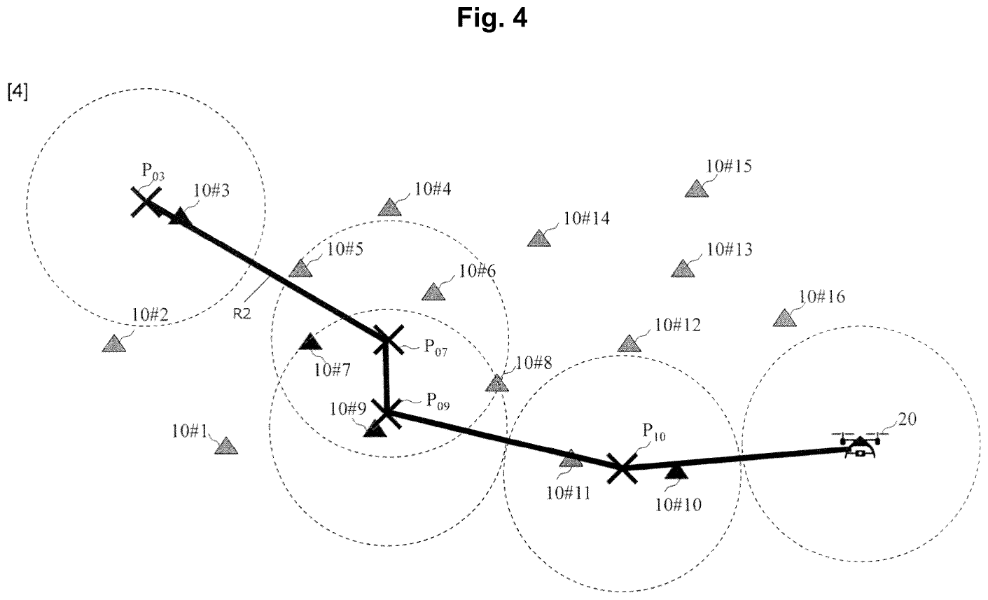

FIG. 4 illustrates an example of a data collection route for collecting sensing data. The mobile base station 20 uses positions P₀₃, P₀₇, P₀₉, and P₁₀ of the sensor terminals 10 #3, 10 #7, 10 #9, and 10 #10 that have acquired the flag information to calculate the shortest route connecting the positions P₀₃, P₀₇, P₀₉, and P₁₀. For example, the mobile base station 20 arranges the positions P₀₃, P₀₇, P₀₉, and P₁₀ in order of proximity to a host apparatus and calculates a route connecting the positions P₀₃, P₀₇, P₀₉, and P₁₀ in order of proximity to the host device. Accordingly, the mobile base station 20 approaches the sensor terminals 10 #3, 10 #7, 10 #9, and 10 #10 using the calculated routes.

As described above, in the system of this disclosure, the mobile base station 20 can extract flag information from the sensor terminal 10 that performs data communication without waiting for the establishment of data communication, move only in the vicinity of the sensor terminal 10 where sensing data to be collected exists in the shortest distance, and collect sensing data. Therefore, the system of this disclosure can reduce the total time required to collect the sensing data and improve the collection efficiency of the sensing data per unit time. Accordingly, since the total time required for collecting the sensing data can be reduced, the system of this disclosure can reduce the battery consumption of the sensor terminals 10 and the mobile base station 20.

### First Embodiment

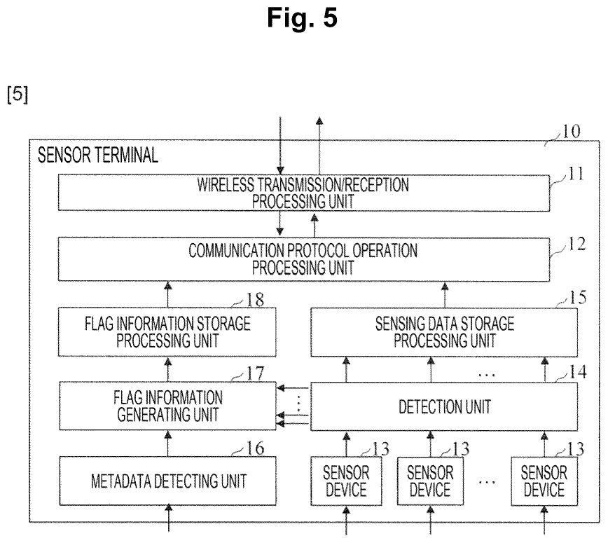

FIG. 5 illustrates a configuration example of the sensor terminal 10 of the embodiment. The sensor terminal 10 includes a wireless transmission/reception processing unit 11, a communication protocol operation processing unit 12, sensor devices 13, a detection unit 14, a sensing data storage processing unit 15, a metadata detecting unit 16, a flag information generating unit 17, and a flag information storage processing unit 18.

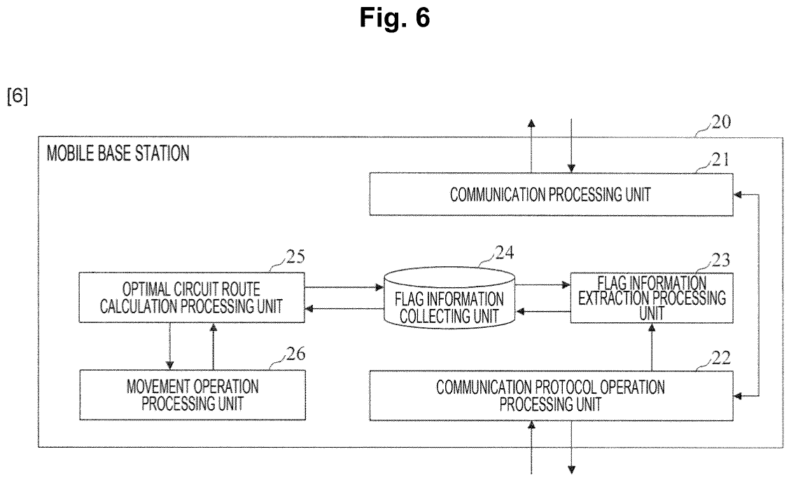

FIG. 6 illustrates a configuration example of the mobile base station 20 according to the embodiment. The mobile base station 20 includes a communication processing unit 21, a communication protocol operation processing unit 22, a flag information extraction processing unit 23, a flag information collecting unit 24, an optimal circuit route calculation processing unit 25, and a movement operation processing unit 26.

The wireless transmission/reception processing unit 11 is a functional unit that communicates with the mobile base station 20. The communication protocol operation processing unit 12 controls information transmitted and received by the wireless transmission/reception processing unit 11 in accordance with the communication protocol. The communication processing unit 21 is a functional unit that communicates with the sensor terminals 10. The communication protocol operation processing unit 22 controls information transmitted and received by the communication processing unit 21 in accordance with the communication protocol.

The sensor device 13 is a functional unit that acquires sensing data. The detection unit 14 detects an event that has occurred in each sensor device 13 and transmits sensor device information, time information, and the like in which an event is detected, to the flag information generating unit 17. The sensing data storage processing unit 15 stores the sensing data acquired by the sensor devices 13 in a data frame.

In the embodiment, the wireless transmission/reception processing unit 11 transmits the flag information and the sensing data to the mobile base station 20. Regarding the flag information, the wireless transmission/reception processing unit 11 stores device information and various items of metadata in the control signals and transmits the control signal. The wireless transmission/reception processing unit 11 stores the sensing data in a payload region of the data frame and transmits the sensing data.

The flag information generating unit 17 generates flag information on the basis of the sensor device information, time information, and the like in which an event transmitted from the detection unit 14 is detected. In addition to a MAC address of the sensor device 13, an event detection time, and the like, metadata such as position information, installer, environment information, and the like may be added to the flag information separately from the information collected from the sensor device 13. The metadata detecting unit 16 is a functional unit that detects any data other than the sensing data.

The flag information storage processing unit 18 stores the generated flag information in the control signal of the wireless communication protocol. The flag information storage processing unit 18 may store data after processing the data, for example, after converting the data into a certain shortened code or dividing (fragmenting) the data into a plurality of frames to be suitable for a form and restriction of the unique extension region. Regarding a storage timing, the data may be sequentially stored every time the data is updated, or a record (log) after the data is accumulated for a certain period or a result of specific processing such as calculation and integration may be stored. In addition, the flag information to be stored may be encrypted and stored using an encryption key set in advance on the sensor terminal 10 side.

The flag information extraction processing unit 23 extracts the flag information stored in the control signal and transmits the flag information to the flag information collecting unit 24. The flag information collecting unit 24 stores the collected flag information as a table. The flag information collecting unit 24 passes necessary flag information in response to the request from the optimal circuit route calculation processing unit 25.

The optimal circuit route calculation processing unit 25 acquires the flag information from the table stored in the flag information collecting unit 24 and calculates the shortest data collection route R2 passing through the reception positions of the flag information from all the flagged sensors. The movement operation processing unit 26 controls the movement of the mobile base station 20 on the basis of the data collection route R2 calculated by the optimal circuit route calculation processing unit 25.

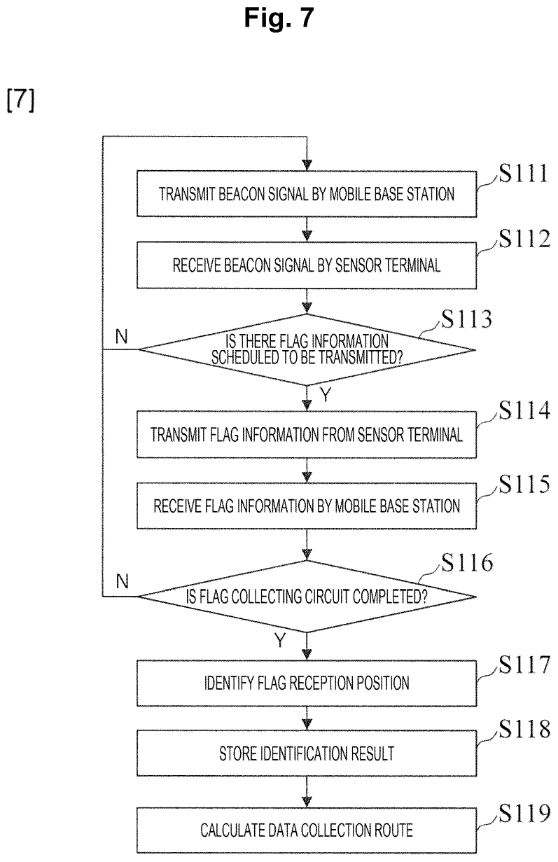

FIG. 7 illustrates an example of a flowchart for collecting the flag information. The mobile base station 20 transmits a beacon signal while moving along the circuit route R1 illustrated in FIG. 3 (S111). The sensor terminals 10 #1 to 10 #16 sequentially receive beacon signals (S112). When receiving the beacon signal, the sensor terminal 10 determines whether there is flag information in the flag information storage processing unit 18 (S113). When there is no flag information scheduled to be transmitted (No in S113), the sensor terminal 10 does not transmit the flag information. When there is the flag information scheduled to be transmitted (Yes in S113), the sensor terminal 10 transmits the flag information (S114), and the mobile base station 20 receives the flag information (S115).

The mobile base station 20 determines whether or not a circuit along the circuit route R1 for collecting the flag information has been completed (S116). When the circuit along the circuit route R1 is not completed (No in S116), the mobile base station 20 executes steps S111 to S115 until the circuit along the circuit route R1 is completed.

When the circuit along the circuit route is completed (Yes in S116), the mobile base station 20 identifies a position where the flag information has been received (S117) and stores the identification result (S118). Accordingly, the mobile base station 20 calculates a data collection route R2 for collecting the sensing data (S119).

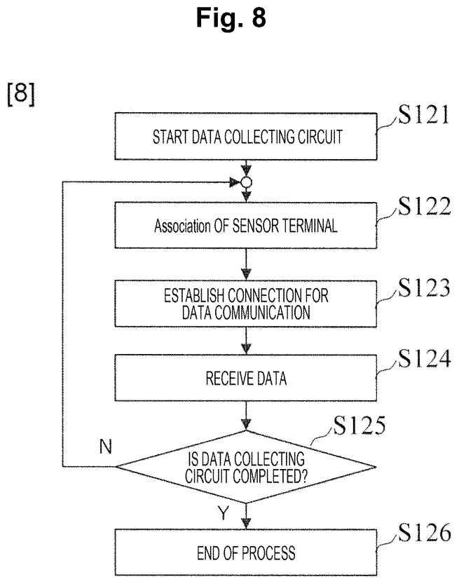

FIG. 8 illustrates an example of a flowchart for collecting the sensing data. The mobile base station 20 starts moving along the data collection route R2 in order to collect sensing data (S121). When approaching the flagged sensor, the mobile base station 20 performs association for establishing communication with the sensor terminal 10 (S122). When the data communication connection with the sensor terminal 10 is established (S123), the mobile base station 20 receives the sensing data (S124).

The mobile base station 20 determines whether or not the collection of the sensing data from all the flagged sensors has been completed. When the collection of the sensing data from all the flagged sensors is not completed (No in S125), steps S122 to S124 are repeated. When the collection of the sensing data from all the flagged sensors is completed (Yes in S125), the sensing data collection processing ends (S126).

### Second Embodiment

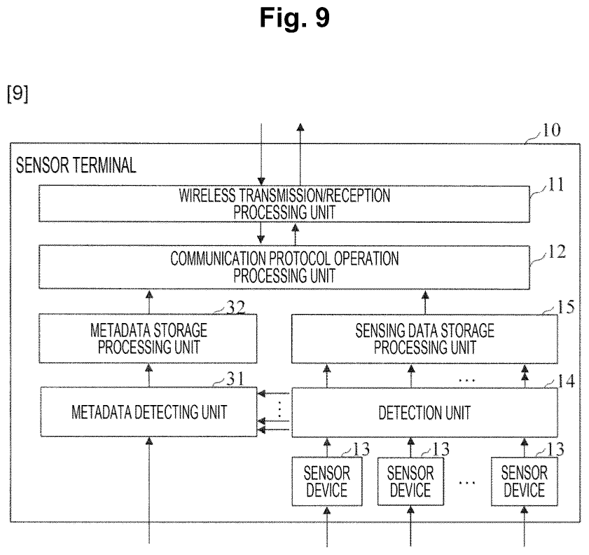

FIG. 9 illustrates a configuration example of the sensor terminal 10 of the embodiment. In the embodiment, a metadata detecting unit 31 and a metadata storage processing unit 32 are provided instead of the metadata detecting unit 16, the flag information generating unit 17, and the flag information storage processing unit 18 in the first embodiment.

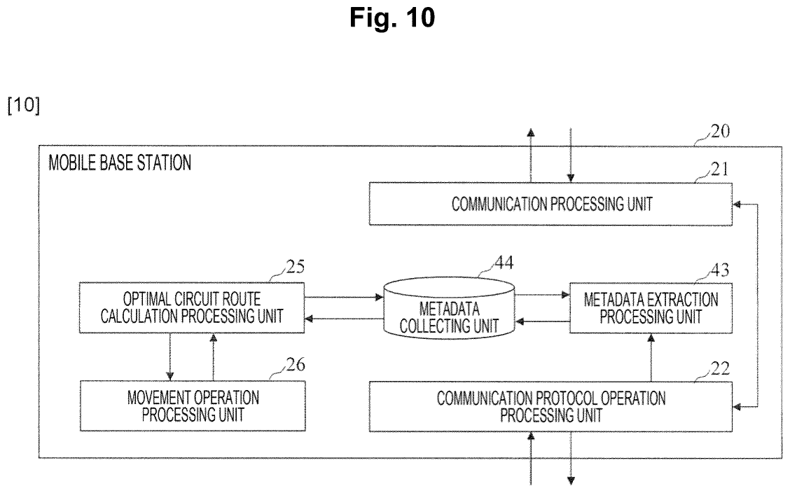

FIG. 10 illustrates a configuration example of the mobile base station 20 according to the embodiment. In the embodiment, a metadata extraction processing unit 43 and a metadata collecting unit 44 are provided instead of the flag information extraction processing unit 23 and the flag information collecting unit 24 in the first embodiment.

The detection unit 14 detects an event occurring in each sensor device 13 and transmits sensor device information, time information, and the like in which the event has been detected to the metadata detecting unit 31.

The metadata detecting unit 31 acquires information (sensor device information, time information, and the like in which the event has been detected in each sensor device) transmitted from the detection unit 14 as a part of metadata and passes the acquired information to the metadata storage processing unit 32. The metadata passed to the metadata storage processing unit 32 includes flag information indicating that the sensor is a flagged sensor. In addition to the sensor device information (such as a MAC address), the event detection time, and the like, other pieces of metadata such as position information, an installer, and environment information may be used.

The metadata storage processing unit 32 stores the metadata acquired from the metadata detecting unit 31 in the control signal of the wireless communication protocol. In this case, the metadata storage processing unit 32 may store data after processing the data, for example, after converting the data into a certain shortened code or dividing (fragmenting) the data into a plurality of frames to be suitable for a form and restriction of the unique extension region.

Further, regarding a storage timing in the metadata storage processing unit 32, the data may be sequentially stored every time the data is updated, or a record (log) after the data is accumulated for a certain period or a result of specific processing such as calculation and integration may be stored. The type and timing of metadata to be stored are not limited to be fixed and may be dynamically changed by an instruction from the mobile base station 20. In addition, the stored metadata may be encrypted and stored using an instruction from the mobile base station 20 or an encryption key preset on the sensor terminal 10 side.

The metadata extraction processing unit 43 extracts the metadata stored in the control signal. The metadata collecting unit 44 stores the metadata extracted by the metadata extraction processing unit 43 as a table. The metadata collecting unit 24 passes necessary metadata in response to the request from the optimal circuit route calculation processing unit 25.

The optimal circuit route calculation processing unit 25 acquires the metadata from the table stored in the metadata collecting unit 44 and determines the flagged sensor in the sensor terminals 10 #1 to 10 #16 based on the metadata. Accordingly, the optimal circuit route calculation processing unit 25 calculates the shortest data collection route R2 passing through all the flagged sensors. The movement operation processing unit 26 controls the movement of the mobile base station 20 on the basis of the data collection route R2 calculated by the optimal circuit route calculation processing unit 25.

In the embodiment, the optimal circuit route calculation processing unit 25 calculates the data collection route R2 on the basis of the metadata. When the position information of the sensor terminal 10 is included in the metadata, the optimal circuit route calculation processing unit 25 calculates the data collection route R2 by using the position information of the flagged sensor included in the metadata. In a case where the position information of the sensor terminal is not included in the metadata, the optimal circuit route calculation processing unit 25 identifies the sensor device information such as the MAC address of the flagged sensor included in the metadata and calculates the data collection route R2 by using a position predetermined for each sensor device information.

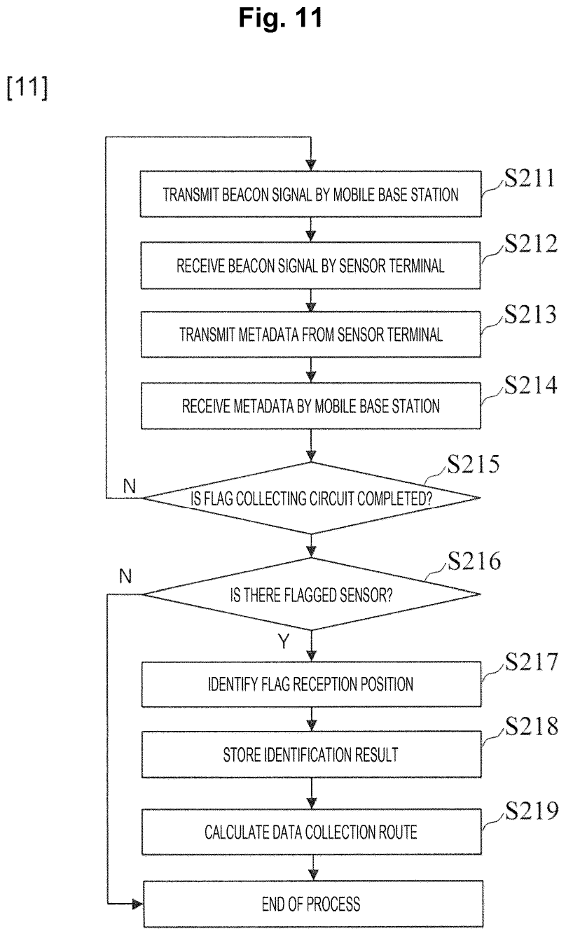

In the embodiment, instead of transmitting the flag information in the first embodiment, metadata is transmitted. Accordingly, a flowchart of collecting metadata is different from that of the first embodiment. FIG. 11 illustrates an example of a flowchart for collecting metadata.

The mobile base station 20 transmits a beacon signal while moving along the circuit route R1 illustrated in FIG. 3 (S211). The sensor terminals 10 #1 to 10 #16 sequentially receive beacon signals (S212). The sensor terminals 10 that have received the beacon signals transmit the metadata (S213), and the mobile base station 20 receives the metadata (S214). The mobile base station 20 determines whether or not a circuit along the circuit route R1 for collecting the metadata has been completed (S215). When the circuit along the circuit route R1 is not completed (No in S215), the mobile base station 20 executes steps S211 to S214 until the circuit along the circuit route R1 is completed.

When the circuit along the circuit route is completed (Yes in S215), the mobile base station 20 determines whether or not there is a flagged sensor on the basis of the metadata of the sensor terminals 10 (S216). When there is no flagged sensor (No in S216), the process ends. When there is a flagged sensor (Yes in S216), steps S217 to S219 are executed.

The mobile base station 20 identifies the position of the flagged sensor using the metadata of the flagged sensor (S217) and stores the identification result (S218). Then, the mobile base station 20 calculates the shortest route passing through the position of the sensor terminal 10 having the data to be collected as the data collection route R2 for collecting the sensing data (S219).

In the embodiment of this disclosure, an example in which the terminal device is the sensor terminal 10 has been described, but this disclosure is not limited thereto. For example, this disclosure can be applied to any terminal device that issues any data, instead of the sensor terminal 10.

In addition, the sensor terminals 10 and the mobile base station 20 of this disclosure can also be implemented by a computer and a program, and the program can be recorded in a recording medium or be provided via a network. A program of this disclosure is a program for causing a computer to be implemented as each functional unit included in the apparatus according to this disclosure and is a program for causing a computer to execute each step included in a method to be executed by the apparatus according to this disclosure.

### INDUSTRIAL APPLICABILITY

This disclosure can be applied to the information and communications industry.

### REFERENCE SIGNS LIST

10 Sensor terminal
11 Wireless transmission/reception processing unit
12 Communication protocol operation processing unit
13 Sensor device
14 Detection unit
15 Sensing data storage processing unit
16 Metadata detecting unit
17 Flag information generating unit
18 Flag information storage processing unit
20 Mobile base station
21 Communication processing unit
22 Communication protocol operation processing unit
23 Flag information extraction processing unit
24 Flag information collecting unit
25 Optimal circuit route calculation processing unit
26 Movement operation processing unit
31 Metadata detecting unit
32 Metadata storage processing unit
43 Metadata extraction processing unit
44 Metadata collecting unit

1. A mobile base station apparatus that collects data from a plurality of terminal devices arranged in a distributed manner,
wherein flag information is collected from each terminal device of the plurality of terminal devices, the flag information indicating that the corresponding terminal device has data to be collected, by using a control signal before establishing communication with the terminal device,
wherein a data collection route for collecting data from the terminal device is calculated by using the flag information; and
wherein data is collected from the terminal device by moving along the calculated data collection route.

2. The mobile base station apparatus according to claim 1, wherein a shortest route passing through a position where the flag information is received is calculated as the data collection route.

3. The mobile base station apparatus according to claim 1,
wherein the flag information is collected from each terminal device through a predetermined circuit route along which the flag information is receivable from each terminal device; and
wherein a position where the flag information is received is identified by using a time when the flag information is received during movement along the circuit route.

4. The mobile base station apparatus according to claim 1,
wherein metadata including the flag information and position information of the terminal device is collected from each terminal device; and
wherein a shortest route passing through a position of a terminal device having data to be collected is calculated as the circuit data collection route.

5. The mobile base station apparatus according to claim 1, wherein data is collected from a terminal device that has established communication when collecting data from the terminal device.

6. The mobile base station apparatus according to claim 5,
wherein the control signal is a probe request frame, and
wherein data stored in a payload region of a data frame is collected when data is collected from a terminal device.

7. A data collecting system comprising:
the mobile base station apparatus according to claim 1; and
the plurality of terminal devices.

8. A method for collecting data in which a mobile base station apparatus collects data from a plurality of terminal devices arranged in a distributed manner, the method comprising:
by mobile base station apparatus
collecting flag information from each terminal device of the plurality of terminal devices, the flag information indicating that the corresponding terminal device has data to be collected, by using a control signal before establishing communication with the terminal device,
calculating a data collection route for collecting data from the terminal device by using the flag information; and
collecting data from the terminal device by moving along the calculated data collection route.
